(19) United States
(12) Patent Application Publication
(10) Pub. No.: US 2023/0009860 A1
(43) Pub. Date: Jan. 12, 2023

(54) EVALUATION DEVICE FOR AN ELECTRONICALLY READABLE BLISTER PACK

(71) Applicant: Schreiner Group GmbH & Co. KG, Oberschleissheim (DE)

(72) Inventors: Stefan WIEDEMANN, Muenchen (DE); Uwe BRAUN, Muenchen (DE)

(73) Assignee: Schreiner Group GmbH & Co. KG, Oberschleissheim (DE)

(21) Appl. No.: 17/776,742

(22) PCT Filed: Nov. 18, 2020
(86) PCT No.: PCT/EP2020/082547

§ 371 Date: May 13, 2022

(30) Foreign Application Priority Data
Nov. 20, 2019 (DE) 10 2019 131 330.9

(51) Int. Cl. A61J 1/03; A61J 7/04

(52) U.S. Cl. CPC A61J 1/035; A61J 7/0436; A61J 2200/30

(57) ABSTRACT

An evaluation device for monitoring the removal of medication from an electronically readable blister pack includes at least the following: an evaluation circuit able to be used to establish interruptions, destructions and/or other damages to electrical conductor tracks of a blister pack, wherein the evaluation circuit for this purpose tests or measures the electrical resistance, the capacitance or another parameter or state of the electrical conductor tracks of a blister pack, and a contact arrangement having a plurality of electrical contacts for contacting and/or otherwise evaluating the electrical conductor tracks of a blister pack, wherein the electrical contacts are connected to the evaluation circuit by electrical lines, wherein the evaluation device is an evaluation device which can be mounted on a wrapping-free and/or unwrapped blister pack.

The application concerns an evaluation device for an electronically readable blister pack. The application further relates to a mounting adapter for an evaluation device and to an electronically readable blister pack.

In the treatment of patients with medications, whether in hospitals and clinics, etc., or also at the patient's home, a factor that has a significant influence on the success of the treatment is the regularity with which the patient takes the medication. If, for example, tablets, capsules or other dosage units of the prescribed medication are not taken by the patient at the prescribed intervals (e.g. at the prescribed times or times of day), but are delayed (whether knowingly or inadvertently) or occasionally not taken at all, it is only possible to a limited extent to draw conclusions about the course of the disease from the prescribed medication.

For this reason, blister packs and evaluation systems are in use for this purpose, with which the time (date and time) of medication withdrawal for each tablet, respectively capsule, in a blister pack can be electronically recorded and stored. For this purpose, blister packs have electrically conductor tracks which are, for example, printed, etched or otherwise produced and are assigned to the cavities of the blister pack. A blister pack generally comprises a plastic foil which is shaped to form cavities, i.e. depressions, respectively protrusions (wherein the cavities or at least most of them being filled with at least one tablet or other medication capsule each), and a closure foil which is planar, respectively flat, wherein the closure foil (which comprises, for example, an aluminum foil or a special composite foil, for example aluminum paper, aluminum plastic or plastic paper) comprises a plurality of conductor tracks and at least one insulation layer between the conductor tracks and the aluminum foil. Within the surface extent of the blister pack, the conductor tracks are routed respectively have such a track that exactly one of the conductive path passes under, respectively over, each cavity; i.e. within the surface area of the electronically evaluable blister pack, each conductor track passes through the surface area of exactly one respective cavity, i.e. overlaps with the latter in the lateral direction. Therefore, when this cavity is opened to remove the tablet, this associated conductor track is severed at this moment. This can be detected electronically, for example by measuring, transmitting and/or storing the resulting change in resistance or capacitance of this conductor track and the time of this change; the stored times allow digital control, respectively electronic monitoring, of the regularity of medication intake, which is also referred to as “medication adherence monitoring”.

Conventional evaluation devices have a contact strip against which the respective blister pack is pushed or pressed with one of its four outer edges of the evaluation device in order to contact the conductor tracks of the blister pack. At this outer edge of the blister pack, the ends of the conductor tracks (e.g. exposed on one side of the closure foil) are lined up next to each other; the conductor tracks of the blister pack thus also form a contact strip of (mating) contacts at this outer edge of the blister pack.

For precise positioning of the blister pack against the evaluation device, an outer packaging for the blister pack made of cardboard or foil, in particular a plastic foil, which is folded several times and wrapped around the blister pack, is conventionally used. This wrapper, respectively wrapper-shaped outer packaging is referred to as a “wallet”. On one side of the repackaged blister pack, the “wallet”, respectively wrapped-shaped outer packaging contains a plurality of recesses whose lateral contours are matched to the lateral contours of the respective cavities of the blister pack, but which, when the blister pack is wrapped with the wallet, come to lie above the closure foil (which is arranged opposite the blister foil) in order to allow the tablets or other dosage units of the medication to be removed through these recesses.

Thus, the wrapped-around wallet ensures that the predefined relative position of the blister pack and evaluation device relative to each other is maintained, so that the contact strip of the blister pack comes to lie in the correct position relative to the contact strip of the evaluation device.

The wallets are dimensioned such that they wrap the blister pack and the evaluation device together.

It is the task of the present application to provide an electronically readable blister pack and an evaluation device intended for this purpose, in order to enable even more reliable electronic reading, respectively evaluation, of blister packs. At the same time, the handling of blister packs is to be simplified.

This task is solved by the evaluation device according to claim 1 and by the blister pack according to claim 16. Furthermore, this task is solved by a mounting adapter according to claim 14. However, such a mounting adapter may also be integrated into the evaluation device.

Some exemplary embodiments are described below with reference to the figures. They show:

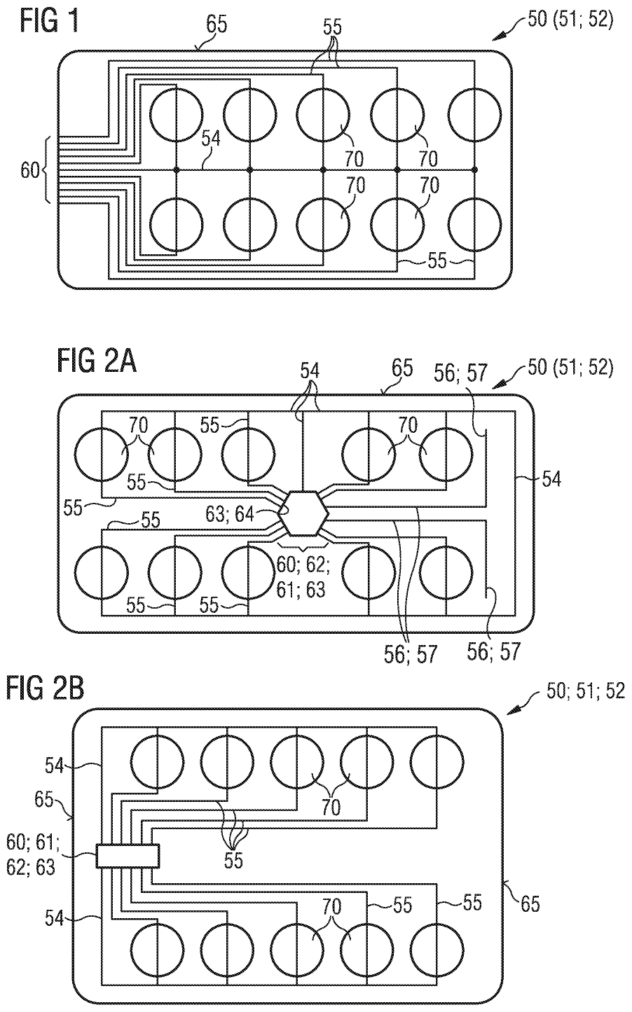

FIG. 1 a conventional blister pack,

FIG. 2A a first exemplary embodiment of a blister pack proposed according to this application,

FIG. 2B a second exemplary embodiment of a blister pack proposed according to this application,

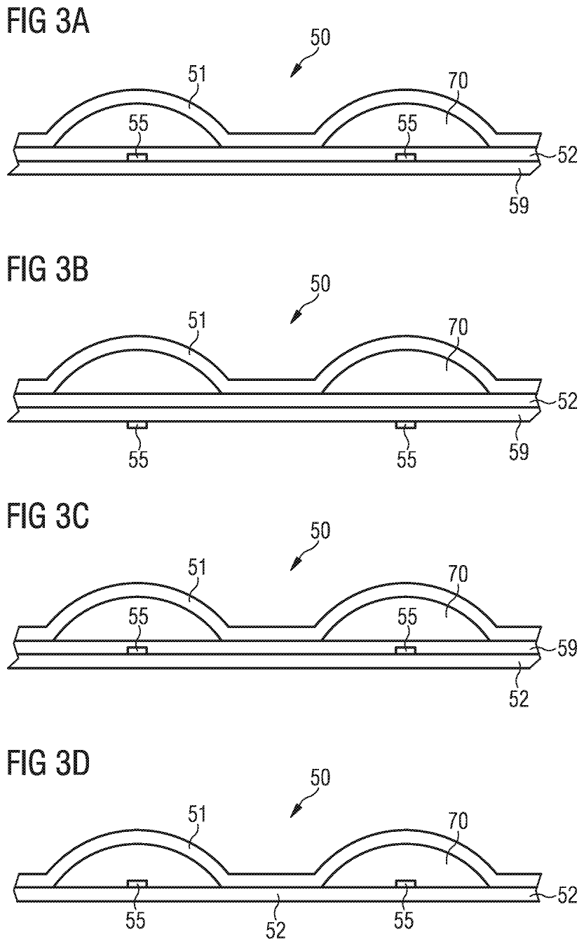

FIGS. 3A to 3D various exemplary embodiments with regard to the layered structure of the blister pack according to the application in schematic cross-sectional view,

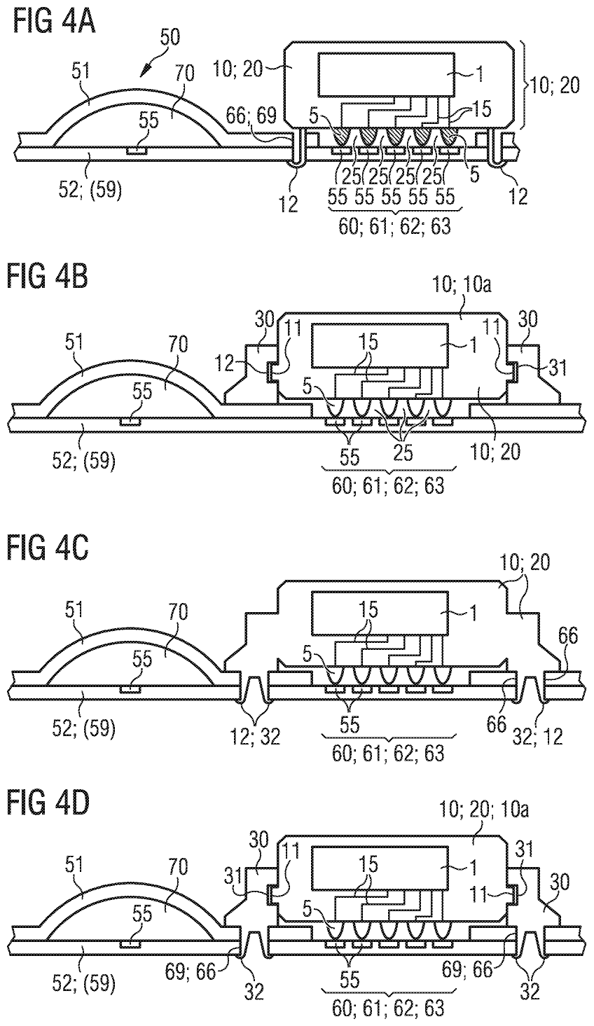

FIGS. 4A to 4D various exemplary embodiments for the evaluation device according to the application, intended for mounting on an unwrapped blister pack, in schematic cross-sectional view,

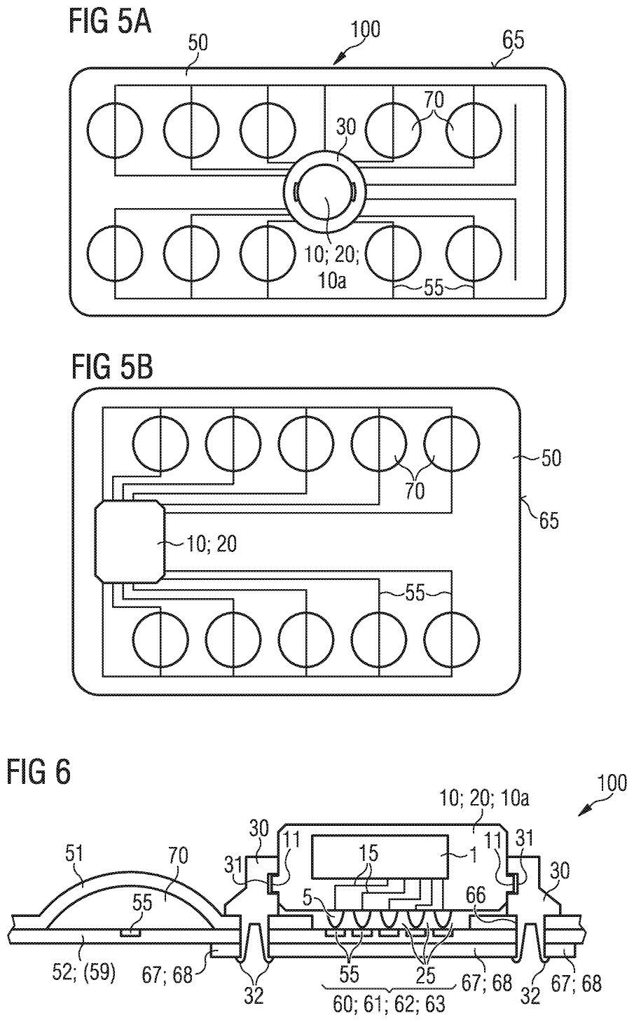

FIGS. 5A and 5B two exemplary arrangements, each comprising a blister pack and an evaluation device mounted thereon,

FIG. 6 a section of an arrangement comprising an electronically evaluable blister pack and an evaluation device mounted thereon, in cross-sectional view,

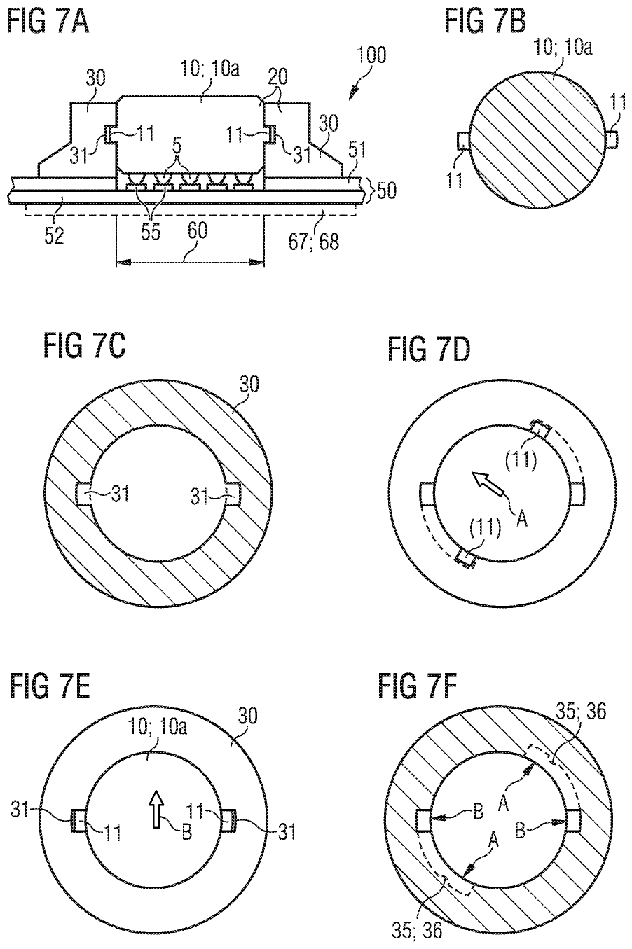

FIGS. 7A to 7F an exemplary embodiment with regard to a coupling mechanism for mechanically coupling an evaluation device or at least its main body and a mounting adapter to each other,

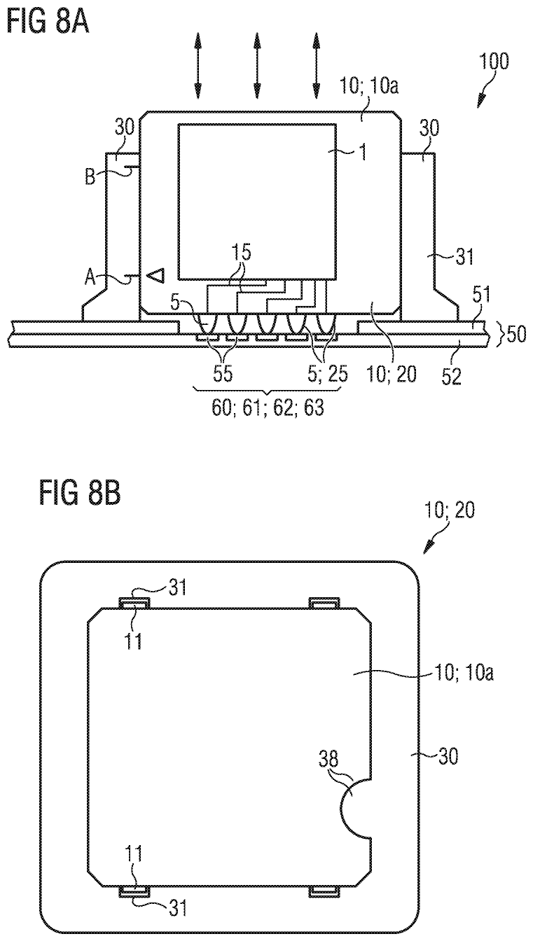

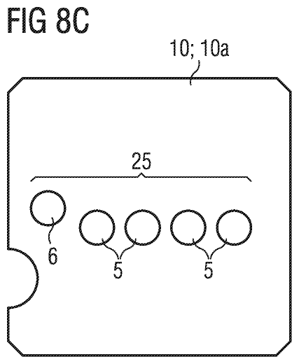

FIGS. 8A and 8B an exemplary embodiment of an evaluation device, the main body of which is coupled to a mounting adapter, in cross-sectional view and in plan view, and

FIG. 8C a bottom view under the main body of the evaluation device of FIGS. 8A and 8B.

For a more comprehensible explanation of the evaluation device proposed according to this application, the blister pack to be evaluated, respectively read out, by this evaluation device, which is also further formed according to some embodiments, will first be explained on the basis of the following figures, before the actual evaluation device and its embodiments are discussed.

FIG. 1 shows a conventional, electronically readable blister pack 50. Within the surface extent of the blister pack 50, which is surrounded by its outer edge 65, exemplary lateral positions of the cavities 70, i.e. the bulges of the blister foil for inserting the tablets, as well as exemplary conductive paths of the electrical conductor tracks 55, which are assigned to these cavities 70, are shown. FIG. 1 and FIGS. 2A and 2B are not intended to be understood as a top view or sectional view of the blister foil or the closure foil of which the blister pack 50 predominantly consists, but rather these figures are intended—irrespective of the respective selectable layer structure of the blister pack—merely to show the respective surface arrangement of cavities and conductor tracks, respectively conductive paths; furthermore, they apply, of course, irrespective of the concrete outline shape of the cavities, which may also be oval or otherwise rounded and/or elongated (instead of circular).

In FIG. 1 it can be seen that in a conventional blister pack the conductor tracks 55 associated with the cavities 70 have contactable conductor track ends which are arranged next to one another at the outer edge 65 of the blister pack 50 and form there a contacting area 60 in the form of a contact strip.

Conventionally, this contacting area 60 is connected to an evaluation device, whereby a contact arrangement (also formed as a contact strip) of electrical contact terminals of the evaluation device contacts the contacts of the blister pack in order to electrically drive and evaluate the conductor tracks 55 of the blister pack 50, which takes place, for example, periodically or continuously in time.

In order to ensure the relative position of the evaluation device and the blister pack required for this purpose, in which both are electrically connected to each other, the evaluation device and blister pack are conventionally placed on top of each other and wrapped with the “wallet”, this means the multiple folded wrapper. A closure on the wallet ensures that the wallet does not open until all tablets have been removed, this means the blister is still in use. After opening the wallet, the old blister pack can be exchanged for a new one.

The following figures (beginning with FIG. 2A) show exemplary embodiments of electronically readable blister packs and evaluation devices provided therefor in accordance with this application, the use of which is facilitated and simplified. At the same time, there is no need to use a wallet or a similar wrapper or wrapping, since thanks to the construction of the blister pack and/or evaluation device proposed according to this application, their handling is less complicated, but at the same time more reliable.

In this application, the respective reference signs are used across figures for all figures of the application; therefore, for explanation of the elements designated thereby, reference can be made to the disclosure for the respective other figures. If a reference sign mentioned in the description does not appear in a figure, reference is made in this respect to the other figures.

FIG. 2A shows a first exemplary embodiment of a blister pack according to the application. In contrast to FIG. 1, the contacting area 60 is not formed as a contact strip arranged at the outer edge 65, in particular not provided at one of the four straight edges of the outer edge 65. Instead, it is provided that the contacting area 60 is a contacting area spaced from the outer edge 65. Although the conductor tracks 55 are still brought together with their free ends (or at least with the contactable or otherwise electrically accessible conductor track sections), the contacting area 60 characterized by bringing together the conductor tracks 55 is located within the surface extent of the blister package.

The contacting area 60 shown in FIG. 2A, which is arranged there approximately in the center of the surface extent (or can be arranged somewhere between the cavities 70 or also between the cavities 70 and the outer edge 65), can be formed as a free area 61 (i.e. as an area free of cavities), in particular as a free area 61 on the externally accessible side, respectively main surface of the blister foil, the closure foil and/or a conductor track label. An evaluation device proposed in accordance with this application can then be mounted on, respectively over this free area, in such a way that the evaluation device is automatically held in the relative position to the blister pack required for evaluating the conductor tracks, without the need for the conventionally used “wallet” or other wrapper or wrapping.

As a result of this circumstance, the evaluation device can in turn be designed to be a blister pack attachment that is portable by the blister pack and does not require a common outer packaging or wrapper to secure and maintain its own relative position.

The same considerations and advantages also apply in the case that the contacting area 60 shown in FIG. 2A is not formed as a free area, but as a recess 62, in particular as an inner opening 63 of the blister foil 51, of the closure foil 52 and/or of a conductor track label connected thereto, or also as a recess 62, respectively inner opening 63 of the blister pack as a whole (i.e. of all its layers). The conductor tracks 55 then lead to an inner edge 64 of the blister pack or at least closely to such an inner edge 64. The contactable conductor track ends of the conductor tracks 55 themselves are preferably accessible from one of the two surfaces, respectively main surfaces of the blister pack 50, i.e. from the normal direction to the surface extension, in particular contactable from there; for example by placing, pressing on or otherwise bringing into contact contact terminals of the evaluation device from this normal direction.

In conventional blister packs, no such inner edge 64 exists, in particular no inner edge or inner opening, in which all conductor tracks 55 are contacted at a distance from the outer edge 65 of the blister pack. Also, a free area positioned spaced from the outer edge between the cavities, respectively within a matrix-shaped arrangement of cavities is not conventionally provided.

In preferred embodiments of the application, it is provided that the evaluation device not only makes electrical contact with the blister pack, but also holds itself independently and permanently to the blister pack without the aid of any enclosures. Such “independent” mounting of the evaluation device to the blister pack is not provided for either conventional evaluation devices or conventional blister packs.

In FIG. 2A, the conductive paths of the conductor tracks 55 to be evaluated (as well as the path of the common connecting line 54 to them) are merely exemplary; the same applies to the (at least) one, optional antenna 56 of the blister pack, which can also be provided in the following figures and can be realized, for example, in the form of one or two antenna lines 57. Insofar as a transmission of the evaluation results of the evaluation device is to take place via radio, for example via RFID, one would conventionally provide the antenna as a component of the evaluation device. However, the attachment of the evaluation device to the blister pack according to the application also makes it possible, as an alternative, to design the blister pack itself with an integrated antenna 56 and to design the evaluation device without an antenna. In this case, only the evaluation electronics and an associated antenna connection need to be connected to the blister pack, respectively its contact area; the permanently secure contact between the evaluation device and the blister pack also enables secure transmission via the integrated antenna in this case.

FIG. 2B shows a second exemplary embodiment of the blister pack with regard to the conductive paths of the conductor tracks 55 and the position at which the contacting area 60 is arranged; although this is located here in the vicinity of the outer edge 65, respectively one of its four edges, it is at a distance therefrom and is also again optionally formed as a free area 61 or as a recess 62. With regard to the explanations in this respect, reference is made to FIG. 2A; the same applies to the figures explained below. The outline shape of the contacting area 60 can be selected in a suitable manner in all figures and other embodiments; its hexagonal, respectively rectangular outline in FIGS. 2A, respectively 2B can be modified respectively designed differently accordingly. In addition, the optional antenna of the blister or the evaluation device is no longer specifically shown from FIG. 2B. Furthermore, the conductive paths can be modified, for example by leading the conductor tracks 55 obliquely over (respectively under) the cavities 70.

FIGS. 3A to 3D show some exemplary variants with respect to the layer structure of the blister packs according to the application in schematic cross-sectional view through the blister pack. For simplification, the cavities 70 are shown unfilled in each case. In FIGS. 3A to 3D, in addition to the blister foil 51, at least the closure foil 52 to be opened during tablet removal is shown; furthermore, a label layer or other layer or foil, in particular a conductor track label 59, can optionally be provided, on the inside (FIG. 3A) or outside (FIG. 3B) of which the conductor tracks 55, 54, 56 of the blister pack are formed, in particular, for example, printed on. According to FIG. 3C, in the layered composite of the blister pack 50, the order of the closure foil 52 and the conductor track label 59 is reversed; the conductor tracks are located between the two layers. According to FIG. 3D, only the closure foil 52 is provided, but no separate conductor track label 59 is provided; the conductor tracks may be applied directly to a surface of the (optionally multilayer) closure foil 52 or incorporated therein.

In all embodiments of the application, the closure foil (i.e., the foil 52 intended for sealing the cavities of the blister pack and preferably directly adjacent to the blister foil 51) may be a single metal foil; in particular, an aluminum foil. Alternatively, the closure foil 52 may also be a special composite foil, respectively a layered composite, e.g. a special composite foil of aluminum-paper, aluminum-plastic, plastic-paper or the like, or a foil of plastic alone.

The conductive path in FIGS. 3A to 3D, in particular the orientations of the cavity-related conductors 55 to be evaluated and/or of the common connecting line 54 (and, if applicable, of the antenna line 57) can be carried out in deviation from these figures; merely simplified for the sake of illustration, all of the conductor tracks 55 shown in FIGS. 3A to 3D are each shown running perpendicular to the drawing plane.

Otherwise, as is conventional, the blister foil 51 and the closure foil (respectively the layered composite partial stack forming the closure foil, possibly also comprising a label layer or label foil 59 in addition to the foil 52) are bonded to one another, e.g. laminated to one another, at least along the outer edge 65 of the blister pack. As is conventional, the outer edge of a blister pack 50 preferably comprises four straight edges and four corners or curves between the four straight edges.

FIGS. 4A to 4D show in schematic cross-sectional view various exemplary embodiments of the evaluation device proposed in this application, each shown in mounted state on an unwrapped blister pack. The various evaluation devices of FIGS. 4A to 4D and of all the following Figures are interchangeable with one another and, in particular, can be combined with any of the exemplary cross-sectional views of FIGS. 3A to 3D and/or with any planar design of the blister pack according to FIGS. 2A, 2B or any other planar design of the blister pack alternative thereto.

In each of FIGS. 4A to 4D, only a surface portion of the blister pack in which the evaluation device is mounted is shown. For the sake of simplicity, the blister pack 50 is shown with the same layered structure as in FIG. 3D, i.e. composed only of the blister foil 51 and the closure foil 52 (in between are the tablets or other dosage units of a medication or other pharmaceutical supplements, which are not shown). The position of the conductor tracks 55 is also merely exemplary.

Each of FIGS. 4A to 4D can be modified in that the evaluation device, other than as shown, can also be mounted on the opposite main surface of the blister pack 50 thereto, i.e. on the side of the closure foil 52 instead of on the side of the blister foil 51. For more practical handling, mounting on the side of the blister foil 51 is recommended, since the evaluation device is then surrounded by the cavities 70, i.e. upward curvatures of the blister foil, and thus does not protrude or only insignificantly protrudes therefrom. For contacting the conductor tracks, on the other hand, depending on the embodiment, attachment on the side of the closure foil 52, respectively of a conductor track label 59, may be easier to implement.

According to FIG. 4A, a contacting area 60 is provided in a surface area of the surface extent of the blister pack 50 which is not occupied by cavities 70, which contacting area 60 is formed, for example, as an initially unoccupied free area 61 and/or as a recess 62, in particular as an inner opening 63 of the blister pack. In FIG. 4A, the contacting area 60 forms a free area; however, at the same time, it also forms a recess at least of the blister foil 51, which is recessed at least locally in order to be able to contact the conductor tracks 55, respectively their exposed ends (or their other accessible conductor track sections). In addition to the recess 62 of the blister foil 51, two optional recesses are provided here in the layer structure of the blister package 50 as a whole, which serve as fastening elements 66 for mounting an evaluation device 10 and are designed, for example, as an inner contour 69. This inner contour 69 can also be regarded as a recess 62, i.e. as a contacting area 60 or at least as an associated component of the contacting area 60. In the contacting area 60, the conductor tracks 55 to be read out are brought together or at least arranged running closely adjacent to one another; in this case, on the side of the closure foil 52 facing the blister foil 51.

In FIGS. 4A to 4D, the evaluation device 10 is designed as a blister pack attachment 20 which, in the mounted state, is supported by the wrapping-free, respectively unwrapped blister pack 50 itself. The blister pack attachment 20 preferably has a lateral surface extension which enables its positioning in spaces between adjacent cavities and/or between an arrangement of cavities and the outer edge of a blister pack, for example in a surface region where a recess (relating to at least part of the layer structure) and/or a free area of the blister pack is present.

Referring to FIG. 4A, the evaluation device 10, respectively mountable blister pack attachment 20 has one or more mounting elements 12 (and/or other mounting unit) for engaging around, engaging with, and/or engaging with an inner contour 69 or other fastening elements 66 of the wrapping-free and/or unwrapped blister pack 50. As a result, the evaluation device 10 independently (and in fact in a predefined relative position suitable for evaluating the blister pack) holds onto the blister pack 50 without the aid of a wallet. In FIG. 4A, the mounting elements 12 are shown as latching elements, for example as hooks, springs or clips, which engage through inner openings, respectively inner contours 69 of the blister pack 50 (but without engaging under or around the outer edge 65 of the blister pack). Alternatively, however, they could be other mechanically engaging elements or counterparts thereof.

By means of the mounting elements 12 of the mountable blister pack attachment 20, the electrical contacts 5 of its contact arrangement 25 are held in the predefined positions for contacting the conductor tracks 55 of the blister pack 50; in particular, pressed against these conductor tracks 55, respectively their exposed contact points in the contacting area 60. After all tablets have been removed from the blister, the evaluation device 10 is dismantled and also read out; for example, by radio, such as by RFID. For this purpose, the evaluation device 10 may make use of an antenna line 56; 57 integrated in the blister pack (see above for FIG. 2A), which contacts it by means of its own antenna connection. The antenna connection may be one of the electrical contacts 5 of the contact arrangement 25, but is not specifically identified in the figures. According to FIG. 4A, the evaluation device 10 is thus formed as a one-piece mountable blister pack attachment 20.

According to FIG. 4B, the evaluation device 10, respectively the mountable blister pack attachment 20 can be of multi-part design and comprise, in particular, a main body 10a and a mounting adapter 30. Preferably, the mounting adapter 30 serves only for mounting the main body 10a on the blister pack 50 in a predefined readout or evaluation position, whereas the main body 10a represents the actual evaluation device 10 and comprises the evaluation circuit 1, the electrical contacts 5 of the contact arrangement 25 and the electrical lines 15 extending between them. The main body 10a of the evaluation device 10 is thus couplable to (i.e. mechanically mountable on) the mounting adapter 30, and preferably removably mountable again, whereas the mounting adapter 30 itself is in turn mounted or still to be mounted on a blister pack. For coupling the main body 10a and the mounting adapter 30 to each other, one or more coupling elements 11 of the main body 10a and such 31 of the mounting adapter 30 are provided, respectively, which engage with each other. Instead of a plurality of coupling elements 11; 31, another suitable single coupling element 11; 31 may also be provided on the main body 10a. respectively on the mounting adapter 30.

Although linguistic and conceptual overlaps exist between the two expressions “mounting” and “coupling”, the application generally speaks of the main body 10a of the evaluation device 10 being “coupled” or coupled to a mounting adapter 30 (or vice versa), whereas it speaks of the evaluation device 10 as a whole and/or a mounting adapter 30 being “mounted” to the (wrapping-free, respectively unwrapped) blister pack. Any adapter 30 provides the mechanical connection, but the electrical contact is preferably made directly between the evaluation device 10, respectively its main body 10a and the blister pack 50.

According to FIG. 4B, the mounting adapter 30 may be permanently or temporarily mounted to the evaluation device 10, for example glued or mechanically connected thereto, for example by its own mounting elements 32 as shown in FIG. 4D, which similarly to the mounting elements 12 of the one-piece evaluation device 10 of FIG. 4A engage in one or more inner contours 69 or other fastening elements 66 of the blister pack or otherwise interlock with fastening elements 66 of the blister pack.

The evaluation device, respectively the blister pack attachment 20 may also be formed as a one-piece regardless of the particular type, shape or other configuration of its mounting elements 12 (see FIG. 4C), which are then fixedly attached to its main body 10a.

Alternatively, the separate mounting adapter 30 may on the one hand be at least temporarily mounted or mountable (by means of its own mounting elements 32) to the blister pack 50, on the other hand be coupled, respectively attachable (by means of its own coupling elements 31) to the evaluation device 10, respectively to the blister pack attachment 20 (and/or to the main body 10a thereof) (FIGS. 4B and 4D). In all cases, there is no longer a need for a wallet to hold the evaluation device 10 and blister pack together. Nevertheless, the evaluation device 10 is reusable, whereas the emptied blister pack is always discarded after readout.

According to FIGS. 4B and 4D (in particular FIG. 4B), the mounting adapter 30 can also be used as a disposable product and disposed of together with the blister pack; however, preferably only after the (actual) evaluation device 10, respectively its main body 10a has been previously detached, respectively uncoupled from the mounting adapter 30.

FIGS. 5A and 5B show exemplary two arrangements 100 comprising a blister pack 50 and an evaluation device 10 mounted thereon. FIG. 5A is preferably based on the blister pack 50 according to FIG. 2A, on which, for example, a multi-part evaluation device 10 comprising a main body 10a and a mounting adapter 30 (for example according to FIG. 4B or FIG. 4D with a preferably round outline) is mounted, which contacts and thereby covers the contacting area 60 shown in FIG. 2A with its own contact arrangement. Here, the main body 10a, i.e. the actual evaluation device 10 is separable from the mounting adapter 30; for example by a coupling mechanism as described further below.

FIG. 5B is preferably based on the blister package 50 as shown in FIG. 2B, wherein for example a one-piece evaluation device 10 (for example as shown in FIG. 4A or FIG. 4C; not necessarily having a round outline, for example having a rectangular outline) is mounted directly on the blister package 50, and removably mounted; for example by means of releasable mounting elements 12 as shown in FIG. 4A or 4C. The two selected combinations of evaluation device 10 and blister pack 50 in FIGS. 5A and 5B are only exemplary; in fact, all combinations are conceivable. Furthermore, the evaluation devices 10 shown in FIGS. 5A and 5B can also each be mounted on the other, opposite main surface, respectively side, of the blister pack 50; i.e. also opposite the side with the cavities 70.

Regardless of the specific figure examples 4B, 4D and 5A, also in principle the evaluation device 10 can comprise a separable main body 10a which can be coupled to the blister pack and/or to a mounting unit 30 mounted or mountable thereon, but which can also be decoupled again, i.e. separated and thus reused. The evaluation device 10 and the mounting adapter are then designed in such a way that at least one (first) predefined, fixed and preferably also fixedly coupling relative position of the evaluation device 10 relative to the mounting adapter 30 and/or to the blister pack 50 exists (which is realized by a suitable coupling mechanism 11; 31) and in which relative position the conductor tracks of the blister pack 50 are reliably contacted by the electrical contacts of the evaluation device 10.

According to preferred further embodiments, it is provided that during coupling there is another, second relative position between the evaluation device 10 and the mounting adapter 30, which is assumed first, for example, and is transferred to the fixed and permanently stable first relative position during coupling to the mounting adapter 30, preferably by a guided relative movement of the evaluation device 10 and mounting adapter 30 with respect to one another. In the case of an evaluation device 10 with a round, respectively circular, outline as shown in FIG. 5A, this relative movement can be, for example, a rotational movement, but alternatively generally also a translational movement, for example by merely pushing on, respectively pulling off.

FIG. 6 shows an arrangement 100 comprising at least one wrapping-free and/or unwrapped electronically evaluable blister pack 50 and an evaluation device 10; 20 whose electrical contacts 5 contact the electrical conductor tracks 55 of the blister pack 50 in the contacting area 60; 61; 62; 63 spaced from its outer edge. Since in this case compressive forces occur between the electrical contacts 5 of the evaluation device 10; 20 and the conductor tracks 55 of the blister pack 50, the fundamental bendability, respectively flexibility, of the blister pack can in unfavorable cases lead to contact interruptions, which could lead to incomplete, contradictory or incorrect readout results. In order to ensure secure and uninterrupted contacting in all cases even under unfavorable circumstances, for example in the case of external force effects due to rough handling, etc., the arrangement 100 preferably further comprises an optional stabilizing element, for example in the form of a stabilizing layer 67 and/or a reinforcing foil 68. The stabilizing element 67; 68 is arranged on the side of the blister pack 50 facing away from the evaluation device 10; 20 and is connected there to the blister pack 50 and/or fastened to the blister pack 50. The stabilizing element 67; 68 extends at least over the contacting area 60; 61; 62; 63 and/or its nearest vicinity, thus for example over the free area or recess, respectively inner opening, but without covering or overlapping the surface area occupied by the tablets to be removed, respectively by the cavities 70.

Corresponding to the inner contour 69 or other type of fastening elements 66 of the blister pack 50, respective inner contours or other fastening elements are preferably also formed in the stabilizing element 67; 68.

As a result, the evaluation device 10 can also engage directly in the stabilizing element 67; 68 with its mounting elements 12 (or, if it is mounted with the aid of a mounting adapter 30, with the aid of its mounting elements 32), for example by reaching through the latter. As an alternative to FIG. 6, however, the evaluation device 10 can also be of one-piece construction, in which case the separation shown between the main body 10a on the one hand and the mounting adapter 30 on the other is omitted.

The optional stabilizing element 67; 68 mentioned with reference to FIG. 6 may be provided in any embodiment of the application; irrespective of other combinations of features.

FIGS. 7A to 7F show an exemplary embodiment with respect to a coupling mechanism by means of which the evaluation device 10 or at least its main body 10a and a mounting adapter 30 can be coupled to each other.

In this regard, FIG. 7A shows a cross-sectional view similar to the cross-sectional view in FIG. 6, but only in the surface area of the contacting area 60 and its immediate vicinity, i.e., shown non-overlapping with adjacent cavities. Furthermore, only the coupling elements 11, 31 by which the main body 10a and the mounting adapter 30 can be coupled to each other are shown, but not the mounting elements 12, 32, whose specific shape and number can be selected as desired. The mounting adapter 30 is at least temporarily mounted to the blister pack 50. As FIG. 7A shows, the main body 10a is coupled to the mounting adapter 30, the mounting adapter 30 is mounted to a blister pack, and the main body 10a is mounted, respectively mountable, and/or positionable at least relative to the blister pack 50 by means of the mounting adapter 30 such that the electrical contacts 5 of the main body 10a directly contact the conductor tracks of the blister pack. As will be explained below, this is precisely the case when the main body 10a is arranged in a predetermined, first relative position A relative to the mounting adapter 30. Referring to FIGS. 7A to 7F, this is a rotational orientation, also denoted by the reference sign A and shown in FIG. 7D.

FIG. 7B shows the main body 10a without the mounting adapter 30, and FIG. 7C shows the mounting adapter 30 without the main body 10a, respectively without the (actual) evaluation device 10. By means of the respective coupling elements 11, respectively 31, of the main body 10a and the mounting adapter 30, both are mechanically coupled to each other, and preferably coupled in a detachable manner. The coupling elements 11 of the main body 10a are, for example, projections or protrusions which project into indentations or other coupling elements 31 of the mounting adapter 30, or vice versa. For simplicity, only two of these coupling elements 11, respectively 31, are shown in each of FIGS. 7A to 7F; in practice, three or even more of them are preferably provided.

FIG. 7D shows the main body 10a and the mounting adapter 30, which are coupled to each other by the interlocking coupling elements 11; 31 (or alternatively by another coupling unit, which may also comprise only a single element or another arrangement of several, also different elements for coupling) in such a way that the main body 10a is in a first predefined relative position A, in which a firm, stable and/or permanent contacting of the conductor tracks 55 of a blister pack is ensured by the electrical contacts 5 of the evaluation device 10 and/or of the main body 10a is ensured. In FIG. 7D, this predefined first relative position A is indicated by a directional arrow indicating an angular orientation of the main body 10a (rotated relative to the adapter 30). FIG. 7D further shows that the coupling elements of the mounting adapter 30 marked 31, which are shown here as insertion openings or other recesses or indentations, comprise not only in their vertically oriented opening channel directly visible from the top view from above, but are also guided laterally around the main body 10a at an e.g. medium depth and/or are continued in the azimuthal direction. This ensures a safely guided rotational movement of the main body 10a relative to the mounted mounting adapter 30. Although not shown pictorially, the two sections of the insertion openings 31 of the mounting adapter 30 that are guided around azimuthally preferably do not run exactly horizontally, but rather helically in a slightly descending manner with increasing angle of rotation. This prevents scratching or other damage to the conductor tracks 55 of the blister pack 50 by the contacts 5 of the main body 10a when the main body 10a is turned and twisted. The two coupling elements 11 of the main body 10a are no longer visible or almost no longer visible from above in the angular position A. With the aid of suitable gripping elements or gripping surfaces (not shown), the main body 10a can be gripped sufficiently securely and/or rotated relative to the mounting adapter 30.

The vertical sections of the insertion openings 31 of the mounting adapter 30, which are always visible from above, allow the main body 10a and mounting adapter 30 to be brought into contact for the first time without endangering or damaging the respective contacts 5, respectively conductor tracks 55; for example, by placing the main body 10a from above; optionally with or without counterpressure, and namely in a second (but first assumed during coupling) predefined relative position B, in which the intermeshing coupling elements 11; 31 are, for example, aligned with one another, are arranged unrotated relative to one another and/or (as shown) the protrusions 11 project into the vertical portions of the insertion openings 31 of the mounting adapter 30. In this second relative position, respectively second angular orientation B (direction of arrow in FIG. 7E), the main body 10a and the mounting adapter 30 can also be separated from each other again.

After placing, respectively inserting, the main body 10a onto, respectively into, the mounting adapter 30, the main body 10a is guided, i.e. twisted, relative to the mounting adapter 30 by a guided relative movement, and in this case preferably by a guided rotational relative movement, from the second predefined relative position B according to FIG. 7E to the first predefined relative position A according to FIG. 7D. When decoupling, the twisting, respectively the guided movement, takes place in the opposite direction again from the first predefined relative position A according to FIG. 7D and thus towards the second predefined relative position B according to FIG. 7E. In this exemplary embodiment, the coupling elements, respectively the coupling unit 20 formed therefrom, from the main body 10a and the mounting adapter 30 are thus implemented as a bayonet connection, respectively bayonet lock.

The main body 10a may, for example, be formed as a capsule, respectively provided with a capsule-like housing, while the mounting adapter 30 serves, for example, as a counter ring, respectively annular or otherwise shaped mechanical counterpart to the main body 10a. In addition, the mounting adapter 30 still has mounting elements 32, not specifically shown in FIGS. 7A to 7F, for its own mounting to the blister pack and/or to a reinforcing layer 67; 68.

FIG. 7F shows as an optional feature of the azimuthally circumferentially guided (and e.g. helically slightly descending with increasing angle of twist) portions of the insertion openings 31 of the mounting adapter 30, which are not visible from above and are therefore shown dashed, that these azimuthal insertion opening portions near the first relative position (angular position A) have and/or generate constriction 35 or narrowing 35 or other surmountable mechanical resistance 36, which causes the mounting adapter 30 to oppose the guided rotational movement of the main body 10a out of the first predefined angular position A (towards the second predefined relative angular position B) with a latching resistance, spring resistance or other mechanical resistance 36, which however is surmountable and is intended to be surmountable. This ensures that the main body 10a remains securely in the first predefined angular position A, which is required for the continuous or time-periodic reading out, respectively monitoring of the conductor tracks of the blister pack by the electrical contacts of the main body 10a, respectively of the evaluation device 10; 20; even in the event of accidental contact with, for example, the main body. Instead of a geometric constriction 35, the mechanical resistance 36 to be overcome can also be achieved by any latching resistor or spring resistor, etc.

The exemplary coupling mechanism explained with reference to FIGS. 7A to 7F also prevents unintentional incorrect contacting of the conductor tracks 50 by the contact terminals 5 of the evaluation device; for this purpose, the relative movement towards the relative position, respectively angular position A can end, for example, with an engagement in the angular position A. For mounting, the exchangeable main body is first pressed into the mounting adapter 30 (formed, for example, as a metal and/or plastic frame) and then removed again after the blister has been emptied, i.e. separated from the mounting adapter 30. Including the pressing into the vertical sections of the coupling elements 31 and/or the engagement in the angular position A, it is also possible to speak here of a push lock or push button lock, although the relative movements used for a pure push lock tend to be purely translational.

The mounting adapter 30 is, for example, a plastic or metal ring which also serves to reinforce and thus stabilize the blister pack in the region of its contacting area 60; in particular if the contacting area 60 is formed as a (circular, angular or arbitrarily outlined) recess 62, punch-out opening or other inner opening 63 of one, several or all films or layers of the blister pack 50. Optionally, the stabilizing layer 67, respectively reinforcing foil 68, shown in dashed lines may be applied or attached for additional stabilization; this may be, for example, a circular plastic or metal plate to prevent or mitigate bending of the blister pack at or near the recess, punch-out, etc.

In deviation from FIGS. 7A to 7F, the main body 10a and mounting adapter 30 may also be angular, respectively rectangular, in cross-section and/or coupled to each other by one or more purely translational (rather than at least also rotational) relative movement; FIGS. 7B to 7F for the rotational movement are then superfluous. For the translatory relative movement, for example, two or four coupling elements 11, respectively 31, can be provided in each case.

As an example of a further conceivable coupling mechanism for mechanically coupling the evaluation device, respectively its main body, to the mounting adapter, FIGS. 8A and 8B show, in cross-sectional view and in plan view, a further evaluation device 10; 20 whose main body 10a is coupled to a mounting adapter 30. In FIG. 8A, this assembly is shown together with a section of the blister pack; in FIG. 8B, without the blister pack. A purely translational relative movement similar to that of a push lock or push button lock (or as other mechanical closure operable by pushing and/or pulling) is provided. For example, there are four coupling elements 11 each of the main body 10a and the mounting adapter 31, but in FIGS. 8A and 8B these are exclusively vertical, i.e. along the normal direction to the blister pack 50, and are therefore only visible in the plan view shown in FIG. 8B. Otherwise, the coupling elements 11; 31 may be formed as in FIGS. 7A to 7F; for example, as a projection, respectively recess, which engage one another.

Shortly before the main body 10a is pressed into a lowest position A, it snaps into the mounting adapter 31; by pressing again or otherwise, the snapping mechanism is released again, and the main body 10a returns to the highest position B, in which it is removed. The lateral outline of the main body 10a is rectangular, for example, and a suitable shaping 38 of the main body 10a and the mounting adapter 31 further ensures that both can be pressed or inserted into each other in only one orientation.

In the embodiments illustrated thus far, the evaluation device and/or its main body has a housing having a size of a typical button cell or tablet or a cavity 70 intended therefor, which facilitates the integration, respectively mounting, to the blister pack. Alternatively, however, the evaluation device 10 may be sized as a control unit mountable to a blister pack, for example having a display and one or more control elements.

Finally, the bottom view below the main body 10a of the evaluation device from FIGS. 8A and 8B, which is shown in FIG. 8C, also shows the electrical contacts 5 of the contact arrangement 25 for contacting in each case one of the conductor tracks 55 of the blister pack 50. In addition to these contacts 5, the contact arrangement 25 optionally comprises a further contact serving as an antenna connection 6, with which an antenna integrated in a blister pack can be connected and operated. In the blister pack itself, on the other hand, the antenna 56; 57 is without any connection to the other conductor tracks 55 to be evaluated, i.e. is galvanically isolated from them.

All embodiments can also be modified in that instead of punching through the blister or at least the blister foil in the entire contacting area, only the base surfaces of the individual contacts are punched through or at least made accessible. For this purpose, in particular, a through-plating of the blister foil, of the closure foil and/or of a conductor track label layer can also be carried out and the contact hole can be filled with a via, i.e. a conductive contact hole filling; for example, in order to make a contact from another side of one or more of these layers.

At an suitable time in the manufacture of the blister foil, the recess 62, respectively inner opening 63, for the contacting area 60 (and/or for the free area 61 of the next layer or foil which becomes accessible underneath) is punched (e.g. as a round or other recess), for example after the cavities in the blister foil 51 have been formed and filled with tablets, capsules or other dosage units and thereafter the closure foil 52 or other composite foil has been laminated on in a positionally accurate manner by heat sealing. During lamination, a predefined lateral relative position between the contacting area 60 (for example in the blister foil 51) and the conductor tracks 55 of the composite or closure foil 52 is ensured. If a counter ring or other mounting adapter 31 is to be mounted already during the manufacture and/or completion of the blister packs, this can then be mounted immediately on the blister pack; even before the format punching for separating the blister packs.

Incidentally, the composite or closure foil 52 may comprise an aluminum foil as well as a label foil having a conductor track layer with formed conductor traces on one side thereof. All of the conductor tracks of the blister pack may be formed by etching, vapor deposition, or otherwise, instead of printing.

If the evaluation device 10 or its main body 10a is too small for practical handling, an adapter (“intermediate adapter”) can be provided and attached elsewhere in the form of an “interposer” connecting the chip (respectively the evaluation circuit 1) by precisely printed contacting lines.

Instead of being press-on contacts, the contacts 5 may also be designed as barbs or other underside contacts (for reaching under individual conductor tracks from below, respectively from the opposite side), as side contacts for lateral pressing or temporary reversible slight bending (in the case of contact with a side edge of a conductor track 55) or in any other way; this applies to all embodiments of the application.

Furthermore, the mounting elements 12; 32 may also be designed and shaped in other ways instead of being hookable, respectively barbed engagement elements (for engaging under or around the blister pack 55 at the edge of an internal opening or recess 62,63); this also applies to all embodiments of the application, namely both for the mounting elements 12 of the main body 10a and for the mounting elements 32 of a mounting adapter 30.

### LIST OF REFERENCE SIGNS

1 evaluation circuit
5 electrical contact
6 antenna connection
10 evaluation device
11 coupling element
12 mounting element
15 electrical line
20 blister pack attachment
25 contact arrangement
30 mounting adapter
31 coupling element
32 mounting element
35 constriction
36 surmountable mechanical resistance
38 shaping
50 blister pack
51 blister foil
52 closure foil
54 common connecting line
55 electrical conductor track
56 antenna
57 antenna line
59 conductor track label
60 contacting area
61 free area
62 Recess
63 Inner opening
64 Inner edge
65 Outer edge
66 Fastening element
67 Stabilizing layer
68 Reinforcing foil
69 Inner contour
70 Cavity
100 Arrangement
A first relative position
B second relative position
a, b main surface

1: An evaluation device (10) for monitoring the removal of medication from an electronically readable blister pack,
wherein the evaluation device (10) comprises at least the following:
an evaluation circuit (1) able to be used to establish interruptions, destructions and/or other damages to electrical conductor tracks of a blister pack, wherein the evaluation circuit (1) for this purpose tests or measures the electrical resistance, the capacitance or another parameter or state of the electrical conductor tracks of a blister pack for this purpose, and
a contact arrangement (25) having a plurality of electrical contacts (5) for contacting and/or otherwise evaluating the electrical conductor tracks of a blister pack, wherein the electrical contacts (5) are connected to the evaluation circuit (1) by electrical lines (15), wherein the evaluation device (10) is an evaluation device (10) which can be mounted on a wrapping-free and/or unwrapped blister pack.

2: The evaluation device according to claim 1, wherein the evaluation device (10) is designed as a blister pack attachment (20) which can be carried by a wrapping-free and/or unwrapped blister pack, which has a lateral surface extent which makes it possible to position the evaluation device (10) in interspaces between adjacent cavities and/or between an arrangement of cavities and the outer edge of a blister pack, in particular in the region of a recess or free area of the blister foil and/or of the closure foil of the blister pack.

3: The evaluation device according to claim 1,
wherein the evaluation device (10) is an evaluation device (10) which is intended for communication by radio but has no antenna and has at least one antenna connection (6), connected to the evaluation circuit (1), for connection to an antenna line integrated in a blister pack.

4: The evaluation device according to claim 1,
wherein the evaluation device (10) comprises a mounting adapter (30) or can be mounted on a mounting adapter (30), wherein the mounting adapter (30) is directly mountable on a main surface of a wrapping-free and/or unwrapped blister pack.

5: The evaluation device according to claim 1,
wherein the evaluation device (10) is reusable and separable from the mounting adapter (30) again, and
that the mounting adapter (30) can be used as a disposable product which is permanently mountable to a blister pack but disposable detached from the evaluation device (10) or from a remaining part of the evaluation device (10).

6: The evaluation device according to claim 1,
wherein the evaluation device (10) is dimensioned as an operating device which can be mounted on a blister pack and has a display and one or more operating elements.

7: The evaluation device according to claim 1,
wherein the evaluation device (10) and/or a mounting adapter (30) encompassed by the evaluation device (10) comprises one or more mounting elements (12; 32) and/or another mounting unit for engaging around, engaging in and/or engaging with an inner contour or with other fastening elements of an wrapping-free, unwrapped blister pack in a predefined relative position relative to the blister pack.

8: The evaluation device according to claim 7,
wherein the evaluation device (10) and/or a mounting adapter (30) encompassed by the evaluation device (10) ensures a fixed fit and/or a fixed relative position relative to a blister pack in the mounted state with the aid of the mounting element or elements (12; 32) or the other mounting unit, without engaging under or around an outer edge of the blister pack.

9: The evaluation device according to claim 1,
wherein the evaluation device (10) or at least one main body (10a) of the evaluation device (10) comprises one or more coupling elements (11) and/or another coupling unit, whereby the evaluation device (10) or at least one main body (10a) of the evaluation device (10) can be coupled to a mounting adapter, which in turn is mounted or mountable to a blister pack,
wherein the evaluation device (10), with the aid of the coupling element or elements (11) and/or the other coupling unit
in a first predefined relative position (A) can be coupled and/or mounted fixedly to the mounting adapter, wherein in this first predefined relative position (A) of the evaluation device (10) relative to the mounting adapter, when the latter is in turn mounted on a blister pack, the conductor tracks of a blister pack are contacted, in particular directly contacted, by the electrical contacts (5) of the evaluation device (10)
is attachable to and/or detachable from a mounting adapter and/or a blister pack connected thereto in a second predefined relative position (B), and
is movable relative to the mounting adapter by a guided relative movement, in particular by a guided translatory and/or rotatory relative movement, from the first predefined relative position (A) to the second predefined relative position (B) and/or from the second predefined relative position (B) to the first predefined relative position (A).

10: The evaluation device according to claim 1,
wherein the evaluation device (10) comprises a main body (10a) containing the evaluation circuit (1) and the contact arrangement (25) with the plurality of electrical contacts (5), as well as a mounting adapter (30) which is directly mounted or mountable on a wrapping-free and/or unwrapped blister pack, wherein
the main body (10a) and the mounting adapter (30) are coupleable to each other,
the mounting adapter (30) is mounted or mountable to a blister pack, and
the main body (10a) of the evaluation device (10) is mountable or at least positionable relative to a blister pack by means of the mounting adapter (30) such that the electrical contacts (5) of the main body (10a) contact the conductor tracks of the blister pack.

11: The evaluation device according to claim 7,
wherein the main body (10a) and the mounting adapter (30) each comprise one or more interlocking coupling elements (11; 31) or a respective other coupling unit for coupling to each other, whereby the main body (10a) and the mounting adapter (30) can engage with each other at least in a first (A) and in a second predefined relative position (B) relative to each other,
wherein the coupling element(s) (11) and/or the other coupling unit(s)
in the first predefined relative position (A) ensuring permanent contacting of the conductor tracks of a blister pack by the electrical contacts (5) of the evaluation device (10) and
oppose a guided movement of the main body (10a) of the evaluation device (10) away from the first predefined relative position (A) towards the second predefined relative position (B) with a latching resistance, spring resistance or other surmountable mechanical resistance which prevents or at least inhibits an unintentional movement from the first relative position (A) towards the second relative position (B).

12: The evaluation device according to claim 1,
wherein the coupling elements (11) and/or the other coupling unit of the main body (10a) and the mounting adapter (30) comprise a bayonet connection or other twistable mechanical connection that
allows a guided rotational movement between the first predefined relative position (A) and the second predefined relative position (B), and
oppose a guided rotational movement of the main body (10a) relative to the mounting adapter (30) leading from the first predefined relative angular position (A) to the second predefined relative angular position (B) with a latching resistance, spring resistance or other surmountable mechanical resistance.

13: The evaluation device according to claim 1,
wherein the coupling elements (11) and/or the other coupling unit of the main body (10a) and the mounting adapter (30) comprise a push lock or other mechanical lock operable by pushing and/or pulling, which allows a guided push movement and/or pull movement between the first predefined relative position (A) and the second predefined relative position (B), but acted upon by a surmountable mechanical resistance.

14: A mounting adapter (30) for at least temporarily mounting on a wrapping-free and/or unwrapped blister pack and for at least temporarily mechanically coupling with an evaluation device according to claim 1,
wherein the mounting adapter (30) comprises at least the following:
one or more mounting elements (32) and/or another mounting unit for at least temporarily mounting directly to a wrapping-free and/or unwrapped blister pack, and
one or more coupling elements (31) or a respective other coupling unit for mechanical coupling to an evaluation device for electronic evaluation of the blister pack.

15: The mounting adapter (30) according to claim 14,
wherein the mounting adapter (30) is a mounting adapter (30) which can be coupled to an evaluation device but can be separated therefrom again and which has one or more coupling elements (31) and/or another coupling unit.

16: An electronically evaluable blister pack (50) comprising at least the following:
a blister foil (51) having a plurality of cavities (70) provided for a respective medication dose,
a closure foil (52) which can be torn open or otherwise destroyed for removing a respective medication dose and which covers and/or seals the cavities (70) of the blister foil (51)
a plurality of electrically conductor tracks (55) associated with a respective cavity (70) and provided in or on the closure foil (52) or otherwise in association with or adjacent to the closure foil (52), such that when a medication dose is removed from a cavity (70), an electronically detectable disruption, destruction or other damage occurs to the electrically conductor tracks (55) associated with that cavity (70),
an outer edge (65) which limits the surface extent of the blister pack (50), and
a contacting area (60) in which the electrical conductor tracks (55) can be contacted or otherwise accessed and thereby electrically evaluated to detect interruption, destruction or other damage of the conductor tracks (55),
wherein the contacting area (60) is a contacting area (60) spaced from the outer edge (65), the conductor tracks (55) of which do not or not all extend to the outer edge (65) of the blister pack (50).

17: The blister pack according to claim 16, wherein in the contacting area (60), in which the electrical conductor tracks (55) are accessible, at least one or some conductor tracks of the plurality of conductor tracks (55) are cut off from the outer edge (65) of the blister pack (50) by the cavities (70) and/or by the remaining conductor tracks.

18: The blister pack according to claim 16, wherein the blister pack (50) has at least one inner opening (63) with an inner edge (64), wherein the contacting area (60) enclosing and/or surrounding the inner edge (64), and wherein the conductor tracks (55) being guided to the inner edge (64) or at least to a portion of the inner edge (64) and/or of the inner opening (63).

19: The blister pack according to claim 15,
wherein the blister pack (50) has a free area (61) located between or outside the cavities, within which the conductor tracks (55) assigned to the cavities (70) pass through in a locally contactable manner and/or end in a locally contactable manner, the blister pack having, in, on or next to the free area (61), one or more fastening elements (66) for mounting an evaluation device and/or a mounting adapter intended for an evaluation device.

20: The blister pack according to claim 16,
wherein the blister pack (50) has an antenna (56) for communication by radio, wherein the antenna (56) being provided as an antenna line (57) in the closure foil (51) or adjacent to the closure foil (51) and/or to the blister foil (52) and being connected to an antenna line connection which is arranged in the contacting area (60) or in the vicinity thereof but is galvanically isolated from the electrical conductor tracks (55) assigned to the cavities (70).

21: An arrangement (100), at least comprising:
a wrapping-free and/or unwrapped, electronically evaluable blister pack (50) according to claim 16, and
an evaluation device (10; 20),
wherein the electrical contacts (5) of the evaluation device (10; 20) contact the electrical conductor tracks (55) of the blister pack (50) in the contacting area (60; 61; 62; 63) spaced from its outer edge (65).

22: The arrangement (100) according to claim 21, further comprising:
A stabilizing element, for example in the form of a stabilizing layer (67) and/or a reinforcing foil (68),
wherein the stabilizing element is arranged on the side of the blister pack (50) facing away from the evaluation device (10; 20) and is there attached to or otherwise
connected to the blister pack (50), to the evaluation device (10; 20) and/or to a mounting adapter (30).
